(19) United States
(12) Patent Application Publication
(10) Pub. No.: US 2026/0268405 A1
(43) Pub. Date: Sep. 10, 2026

(54) SYSTEMS AND METHODS FOR PREVENTING INFORMATION AND PLATFORM LEAKAGE AND IMPROVING EXECUTION IN COMPLEX MULTI-COMPONENT ELECTRONIC TRANSACTION PROCESSING

(71) Applicant: Intercontinental Exchange Holdings, Inc., Atlanta, GA (US)

(72) Inventors: William Pierce Lord, Fair Haven, NJ (US); Satish Vedantam, Short Hills, NJ (US)

(73) Assignee: Intercontinental Exchange Holdings, Inc., Atlanta, GA (US)

(21) Appl. No.: 19/355,285

(22) Filed: Oct. 10, 2025

Related U.S. Application Data
(60) Provisional application No. 63/768,517, filed on Mar. 7, 2025.

(51) Int. Cl. G06Q 40/04

(52) U.S. Cl. CPC G06Q 40/043

(57) ABSTRACT

Systems, methods, and non-transitory computer readable media for electronic transaction processing. A processor may: receive a request for a multi-component electronic transaction from a requester system; perform a first validation process on the request; transmit the request to one or more responder systems; receive one or more responses before expiration of a first predetermined time period; perform a second validation process on the one or more responses; generate an aggregated response comprising a value of the one or more values for each component; transmit the aggregated response to the requestor system; receive an authorized transaction from the requestor system before expiration of a second predetermined time period; automatically initiate an execution process for the authorized transaction responsive to a third validation process; receive order execution details from an external system; and transmit the order execution details to the requestor system and the one or more responder systems.

### TECHNICAL FIELD

The present disclosure generally relates to systems and methods for preventing information and platform leakage, increasing efficiency, and reducing messaging overhead in complex multi-component electronic transaction processing.

### BACKGROUND

Systemic problems exist in the field of electronic trading systems. For example, existing electronic trading systems very often have a technical problem of efficiently handling electronic messages to and from participants of various electronic transactions, particularly time-sensitive transactions related to complex multi-component transactions. While conventional electronic trading platforms may enhance trading efficiency of complex multi-component transactions (e.g., allowing users to exchange electronic messages), there are inherent inefficiencies in the electronic transaction process and the configuration of conventional trading platforms that cause technical burdens on these electronic systems.

For example, during a typical negotiation process for a complex multi-component transaction, there is often extensive back and forth between the participants. The storage and processing requirements for the transmission/reception of these electronic messages can take away computing resources from other tasks and take up bandwidth of communications networks. Further, conventional trading platforms may be vulnerable to information leakage (i.e., unintended disclosure of confidential transaction information to unauthorized parties).

Accordingly, there is a need for an entirely new electronic trading system with specially configured hardware and a specific set of rules that can increase efficiency (e.g., in transmission volume) and reduce information leakage (e.g., via increased security of communications) as compared to conventional electronic trading systems.

### SUMMARY

Aspects of the present disclosure relate to methods, systems, and non-transitory computer readable media for electronic transaction processing. A request may be received via a communications interface for a multi-component electronic transaction comprising a plurality of components from a requestor system. The request may be generated based on user input to a first interactive presentation displayed on an interactive graphical user interface (“GUI”) of the requestor system and identifying a plurality of selected responders. A first validation process may be performed on the request. The request may be transmitted, via the communications interface, to one or more responder systems associated with the plurality of selected responders. One or more responses from among the one or more responder systems may be received, via the communications interface, before expiration of a first predetermined time period. The one or more responses may include one or more values for at least a portion of the plurality of components. The one or more responses may be generated based on user input to a second interactive presentation displayed on a respective interactive GUI of the one or more responder systems. A second validation process may be performed on the one or more responses. An aggregated response may be generated including a value of the one or more values for each component of the plurality of components. The value may meet a predetermined characteristic. The aggregated response may be transmitted, via the communications interface, to the requestor system. An authorized transaction may be received, via the communications interface, from the requestor system before expiration of a second predetermined time period. The authorized transaction may be generated based on user input to a third interactive presentation displayed on the interactive GUI of the requestor system. An execution process may be automatically initiated for the authorized transaction responsive to a third validation process. The execution process may include sending one or more electronic messages to one or more external systems via the communications interface. Order execution details may be received, via the communications interface, from an external system of the one or more external systems. The order execution details may be transmitted, via the communications interface, to the requestor system and the one or more responder systems.

### BRIEF DESCRIPTION OF THE DRAWINGS

FIG. 1A is a functional block diagram of an example portfolio trade option (“PTO”) platform, according to an example of the present disclosure;

FIG. 1B is a functional block diagram of a PTO server, according to an example of the present disclosure;

FIGS. 2A and 2B are flow charts illustrating an example PTO process, according to an example of the present disclosure;

FIG. 2C is a signal flow diagram illustrating a successful completion of an example PTO process, according to an example of the present disclosure;

FIG. 3 is a diagram illustrating a first interactive presentation, according to an example of the present disclosure;

FIG. 4 is a diagram illustrating a second interactive presentation, according to an example of the present disclosure;

FIG. 5 is a diagram illustrating a third interactive presentation, according to an example of the present disclosure; and

FIG. 6 is a functional block diagram of a PTO system in the example form of a computer system, according to an example of the present disclosure.

### DETAILED DESCRIPTION

One example of a conventional process for generating a complex multi-component transaction relates to portfolio trading. Portfolio trading is a conventional method of grouping together multiple components (e.g., bonds to buy and/or sell), and execute a transaction with the components together as a single package (e.g., a “basket”). Bulk trades of multiple components (e.g., bonds) may generate cost savings, mitigate operational risk, and reduce market slippage. Portfolio trading may allow users to avoid the time-consuming task of executing each security on a line-by-line basis. Instead, users may execute a large number of bonds in a single transaction.

In a conventional portfolio trade process, participating entities (e.g., buyers and sellers) may typically include institutional investors such as mutual funds, pension funds, or insurance entities looking to buy or sell many bonds in a single transaction. Dealers may typically include financial institutions or brokers who facilitate the trade and may price the bonds and provide liquidity. Portfolio trading may be carried out on a trading platform where a requestor may send a portfolio trade request to selected dealers and the invited dealers may respond to the request. Custodian entities may hold the securities on behalf of the buyers and sellers and ensure the proper settlement of trades.

Bonds within a conventional portfolio trade may encompass both liquid and illiquid instruments with varying credit quality and durations and across a multitude of sectors. The basket is typically sent to a limited number of dealers for negotiation. Ultimately, the requester of the portfolio trade may choose the dealer with the most aggressive pricing on the entire basket. Once the requestor and winning dealer decide to trade the basket at the agreed price, each line-item order may be fed back to the client’s order management system via straight-through processing. Rather than trading each bond individually, which would require finding the right counterparty (e.g., via one or more means of communication such as telephone, text messaging, instant messaging, etc.) and negotiating each price — a process that may involve hours of trawling through spreadsheets and endless back-and-forth before the buy-side is able to fully complete the transaction — portfolio trading may allow institutional investors to efficiently buy and/or sell many bonds in a single transaction.

Conventional portfolio trades are typically shown to a small group of large dealers that have the capacity to absorb a large volume of risk in one transaction. Because only a small group of dealers may be invited, the overall market may not be alerted to a buy or sell program, thereby reducing the risk of market adjustments and front running. Usually, an entire basket of orders may be traded — there may be no partial fills or incomplete orders. Instead, there is often negotiation between the requestor and any of the dealers to adjust the composition of the basket (e.g., to remove one bond or add another). Portfolio trading may allow traders and portfolio managers to rebalance their portfolios more efficiently, achieving their target sector weighting or average duration in a single trade.

Typically, in a conventional portfolio trade, a requestor may submit a list of orders (e.g., 20 or more, and sometimes up to 1,000 orders). Each order may include at least three pieces of information: bond identifier, trade size, and direction (i.e., buy or sell). The portfolio trade may be submitted via a trading platform and may receive responses. Typically, the entire basket of bonds may be traded together and the resulting trade may be executed with a single dealer firm. The trade is typically negotiated with a small number of counterparties to ensure better pricing and execution with less information leakage. Dealers may analyze and price the bonds at both the security and basket levels, providing a comprehensive quote for the entire portfolio.

While electronic trading platforms may enhance trading efficiency of portfolio trades (e.g., allowing traders to exchange electronic messages), there are inherent inefficiencies in the conventional portfolio trading process and the configuration of conventional trading platforms that cause technical burdens on these electronic systems. For example, during the negotiation process, there is often extensive back and forth between the requestor and the dealers. The requestor may ask for changes to the basket of bonds to better meet their investment objectives or to improve pricing. Dealers may also suggest changes to manage their risk exposure or to include bonds that are easier to trade. While this negotiation may ensure that both parties are satisfied with the final composition of the portfolio, this back and forth communication may be time consuming and may result in a large volume of electronic messages that need to be sent between one or more of order management systems (“OMS”) and execution management systems (“EMS”) of each party. Each of these electronic messages need to entered by a user via plain text into a graphical user interface (“GUI”) of the respective system, the plain text must be converted to data, the data must be routed to and stored in at least a temporary cache such as a random-access memory (“RAM”) or a more permanent non-volatile memory such a database, the stored data must be packaged and/or reformatted into an electronic message, and a communications interface must send the electronic message via a communications network. The reverse process must then be performed by the receiving system to be able to present the message on another interactive GUI. The processing requirements for the transmission/reception of these electronic messages can take away computing resources from other tasks and take up bandwidth of the communications network.

Further, these conventional trading platforms may be vulnerable to information leakage as these electronic communications may not be properly secured. Information leakage in bond trading refers to the unintended disclosure of confidential trading information to unauthorized parties. This leakage may lead to adverse market reactions prior to a trade being executed, which may impact pricing and execution costs. For instance, if a large bond trade order is visible to other market participants before execution, it may lead to front-running, where others trade ahead of the order, causing price movements that disadvantage the original trader. Information may also be inadvertently shared through conversations or electronic communications between brokers and clients. For example, if a broker discusses a client’s large bond trade with another party, it may lead to market rumors and subsequent price adjustments. The risk of information leakage increases if users communicate outside of these electronic platforms during the back and forth modification process. In conventional portfolio trading, where multiple trades are executed simultaneously to rebalance or adjust a portfolio, the risk of information leakage is heightened due to the complexity and size of the trades. A portfolio trade can be large enough to have an impact on the market price of bonds.

Accordingly, there is a need for an entirely new electronic trading platform that can increase efficiency (e.g., in transmission volume) and reduce information leakage (e.g., via increased security of communications) as compared to conventional electronic trading systems.

The present disclosure includes exemplary implementations of systems, methods, and non-transitory computer readable medium directed to a portfolio trade option (“PTO”) platform with a specific hardware configuration and set of rules (i.e., a PTO process) that may reduce the number of electronic messages generated, transmitted, received, and processed by order sending entities (e.g., OMSs and/or EMSs) when executing a large number of bonds in a single transaction. The PTO process of the present disclosure is an electronic trading method/protocol that may include broadcasting a list of bond orders to responders (or other market participants) by selective invitation via a trading platform. As discussed in detail below, the PTO process of the present disclosure provides technical improvements over conventional systems and offers unique benefits for the requestors, responders, trading platform and bond market structure. Although the examples of the PTO process described herein include bonds as a tradeable instrument, the PTO process may be utilized for any tradeable instrument, including but not limited to, cryptocurrencies, fiscal currencies, equities, etc.

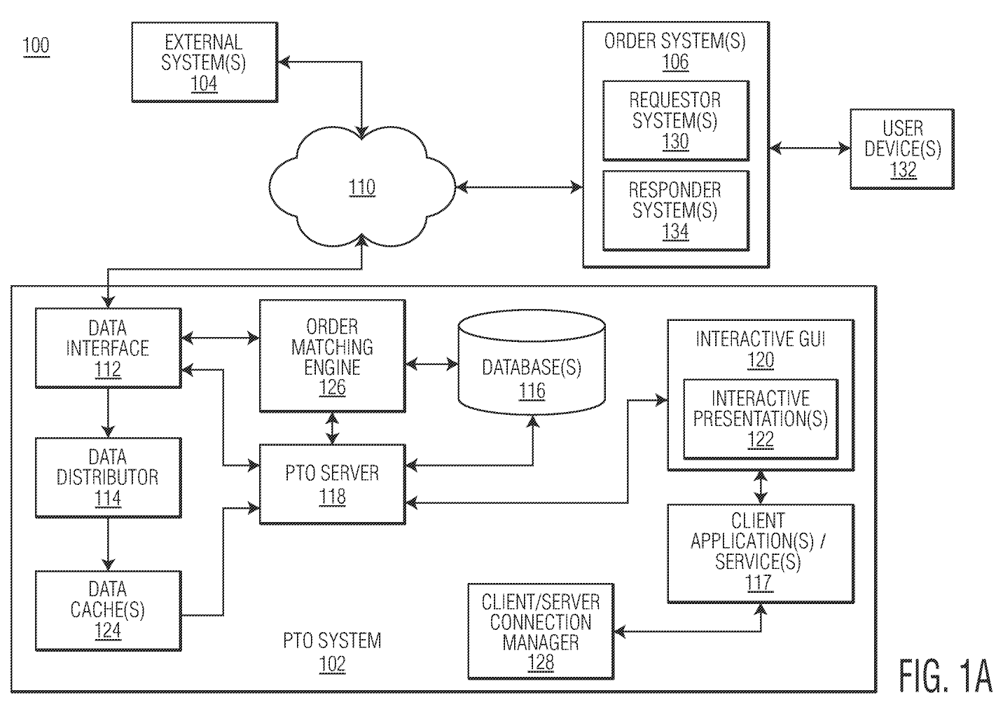

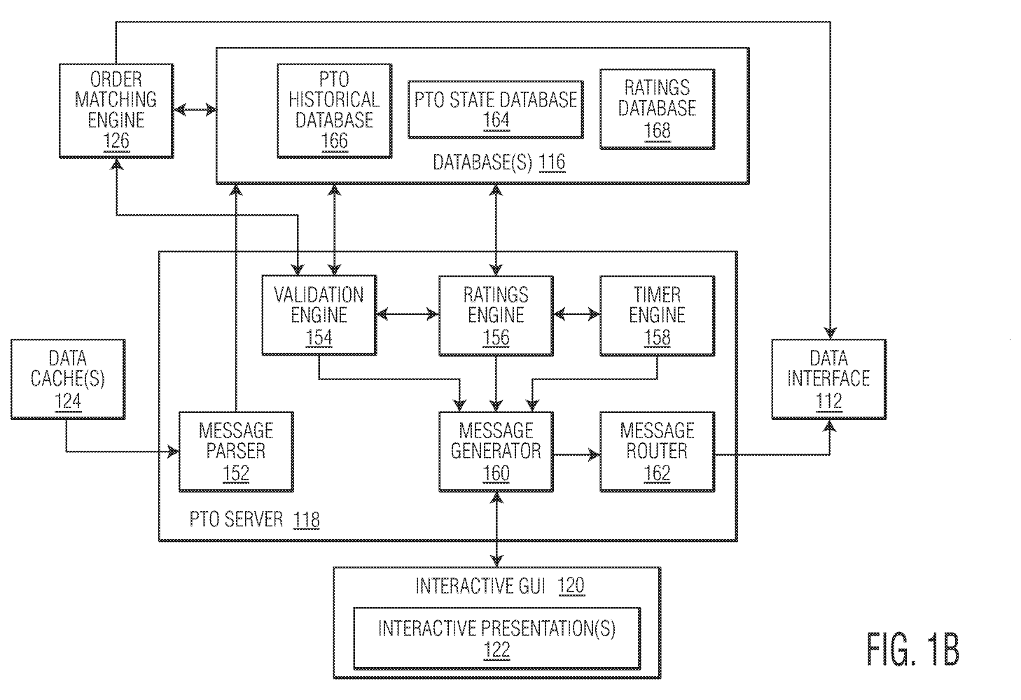

Referring now to FIG. 1A, a functional block diagram of an example PTO platform 100 is shown. The PTO platform 100 may include a PTO system 102, one or more order systems 106, one or more user devices 132, and one or more external systems 104. In some examples, one or more components of the PTO platform 100 (e.g., the PTO system 102, the one or more order systems 106, and the one or more external systems 104 may be communicatively coupled via one or more networks 110. The one or more networks 110 may include, for example, a private network (e.g., a local area network (LAN), a wide area network (WAN), intranet, etc.) and/or a public network (e.g., the Internet).

In general, the one or more order systems 106 may include one or more of a server computer, a desktop computer, a laptop, a smartphone, or any other electronic device known in the art configured to receive, capture, and store data (e.g., market data) and/or disseminate any suitable data (e.g., electronic orders, etc.). The one or more order systems 106 may include one or more requestor systems 130 and one or more responder systems 134 configured to exchange various types of electronic messages (e.g., orders) with the PTO system 102 via network 110. In some examples, the one or more requestor systems 130 and/or the one or more responder systems 134 may include one or more of an OMS and an EMS (discussed further below). The one or more requestor systems 130 and the one or more responder systems 134 may generate and/or store order details (e.g., symbol, side, quantity, available to trade, limit, etc.).

The one or more requestor systems 130 and one or more responder systems 134 may be in communication with one or more user devices 132. In general, the one or more user devices 132 may include any combination of mobile and/or stationary communication device such as mobile phones, smart phones, tablets computers, laptop computers, desktop computers, server computers or any other computing device configured to capture, receive, store and/or disseminate any suitable data. The one or more user devices 132 may include a non-transitory memory, one or more processors including machine readable instructions, a communications interface which may be used to communicate with one or more of the one or more requestor systems 130 and the one or more responder systems 134, a user input interface for inputting data and/or information and/or a user display interface for presenting data and/or information. The one or more user devices 132 may also be configured to format and display an interactive GUI 120 generated by the PTO system 102 on the user interface of the one or more user devices 132.

In some examples, the PTO platform may include one or more external systems 104. In general, the one or more external systems 104 may include one or more of a server computer, a desktop computer, a laptop, a smartphone, or any other electronic device known in the art configured to receive, capture, and store data (e.g., electronic orders, etc.) and/or disseminate any suitable data (e.g., market data). In some examples, the one or more external systems 104 may be any electronic exchange where participants can buy and sell tradable instruments, such as (without being limited to) bonds. The one or more external systems 104 may include one or more of a bond trading platform, a trade capture system, a compliance system, a risk management system, a custodian system, a trade reporting system, a regulatory trade repository, an accounting system, and a clearinghouse. The one or more external systems 104 may receive orders from one or more of the one or more order systems 106 and the PTO system 102. In some examples, the one or more external systems 104 may be a source of real-time market data and/or information (e.g., news information) that may be relevant to market data that may be distributed to one or more of the one or more order systems 106 and the PTO system 102. In an example, real-time market data may be transmitted by the one or more external systems 104 to one or more third party systems that package and distribute the market data to the one or more order systems 106 and the PTO system 102. Market data that may be distributed by the one or more external systems 104 may include, for example, price data and/or trade-related data associated with one or more tradeable financial instruments.

The PTO system 102 may include a data interface 112, a data feed distributor 114, one or more data caches 124, at least one PTO server 118, an order matching engine 126, one or more databases 116, an interactive GUI 120 configured to generate one or more interactive presentations 122, one or more client applications and/or services 117, and a client / server connection manager 128. In some examples, the one or more components of the PTO system 102 may communicate with each other via a data and control bus. Although the PTO system 102 is shown as one component (e.g., a server), the PTO system 102 may include one or more components (e.g., one or more servers) that are co-located and/or linked across one or more networks.

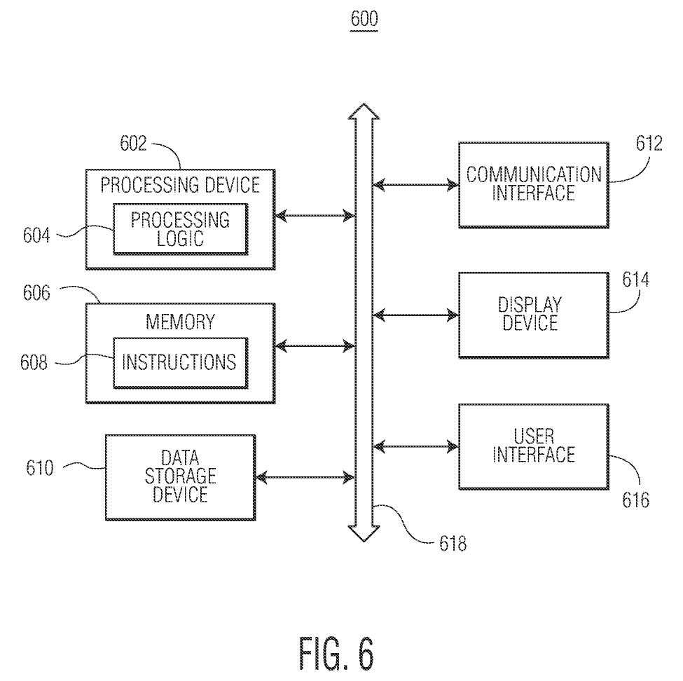

The PTO system 102 may include at least one processor (e.g., processing device 602 shown in FIG. 6) and non-transitory memory (e.g., memory 606 shown in FIG. 6) storing one or more routines and or algorithms for performing the functions of the PTO system 102 described herein. An example implementation of one or more components of the PTO system 102 is shown by computer system 600 (shown in FIG. 6). In general, the PTO system 102 may include one or more of a server computer, a desktop computer, a laptop, a smartphone, or any other electronic device known in the art configured to receive, capture, and store data (e.g., market data and/or electronic messages) and/or disseminate any suitable data (e.g., electronic messages and/or electronic orders, etc.).

The PTO system 102 may communicate with the order systems 106 (e.g., the one or more requestor systems 130 and the one or more responder systems 134), as well as (in some examples) the one or more external systems 104 via the data interface 112. The data interface 112 may include one or more input and/or output interfaces (e.g., an electronic device including hardware circuitry, an application on an electronic device) for communication with the one or more requestor systems 130 and the one or more responder systems 134 and other components of the PTO platform 100. The data interface 112 may include security protection (e.g., encryption, decryption) to protect the integrity of the communications. In an example, the data interface 112 may communicate with the one or more requestor systems 130 and the one or more responder systems 134 (as well as the one or more order systems 106 generally) via a Financial Information eXchange (FIX) protocol, which is a secure open electronic communications protocol designed to standardize and streamline electronic communications in the financial services industry. The FIX protocol may support multiple formats and types of communications between financial entities including trade allocation, order submissions, order changes, and execution reporting.

In an example, the data interface 112 may perform one or more of filtering, data normalization, data reformatting, data aggregation and the like. In some examples, electronic data that may be obtained by the data interface 112 may include data that may be unable to be processed (e.g., data that includes one or more errors and the like). In some examples, the one or more order systems 106 (e.g., the one or more requestor systems 130 and/or the one or more responder systems 134) may transmit data with various unique, non-standard values and/or data formats (e.g., proprietary formats). Furthermore, data content may correspond to different forms of data, such as different currencies, date formats, time periods, etc.

Non-limiting examples of data filtering that may be performed by the data interface 112 may include excluding null data values, excluding corrupted data, excluding outlier data values (e.g., a data value outside of a pre-defined value range, outside of a pre-defined time range) and the like.

In some examples, the data interface 112 may reformat the collected data to one or more common formats and/or normalize the collected data. In some examples, the data interface 112 may be configured to aggregate and/or combine at least a portion of the collected data (e.g., according to one or more pre-defined categories (such as a type of data, one or more predetermined time periods, etc.). The data interface 112 may normalize data to ensure that formatting / naming / categorization of the data is consistent. This may allow the data to be processed by the PTO system 102 and displayed by the interactive GUI 120 in a consistent, normalized manner, regardless of the original data source.

Data feed distributor 114 may be configured to receive the collected data from the data interface 112 and route the collected data to an appropriate data cache within the one or more data caches 124. Because of the amount of data and real-time updates to the data, the one or more data caches 124 may, in some examples, be a temporary random-access memory (RAM) or other type of high-speed short-term memory. By storing the data in this manner, the data feed distributor 114 may reduce the amount of non-volatile memory required for the PTO system 102 to operate and may increase processing efficiency while reducing latency. RAM is a form of electronic computer memory that can be read and changed in any order. A RAM device may allow data items to be read or written in almost the same amount of time irrespective of the physical location of data inside the memory, in contrast with other direct-access data storage media (such as hard disks and magnetic tape), where the time required to read and write data items varies significantly depending on their physical locations on the recording medium, due to mechanical limitations such as media rotation speeds and arm movement.

The PTO server 118 may be configured to communicate with various components of the PTO system 102, including the data interface 112, the one or more data caches 124, the order matching engine 126, the one or more databases 116, and the interactive GUI 120. Although not shown in FIG. 1A, the PTO server 118 may also be configured to communicate with the one or more client applications and/or services 117, and/or the client / server connection manager 128. The PTO server 118 may be configured to retrieve data from the one or more data caches 124 and perform one or more operations, including the PTO process described herein, including the generation of PTO orders that may ultimately be sent to the order matching engine 126 for execution of the PTO order. In general, the one or more databases may be configured to store one or more of requestor and/or responder rating information, PTO requests, PTO responses, PTO orders, and order execution details. In an example, the PTO server 118 may include a tick engine and may be coupled to the one or more databases 116 to enable processing of large amounts data that may change rapidly (e.g., user orders, market events, quotes, transaction data, etc.). The PTO server 118 and the one more databases are discussed further below with respect to FIG. 1B.

The order matching engine 126 may be configured to communicate with the data interface, the PTO server 118 and the one or more databases 116. The order matching engine 126 may match and process all PTO orders and generated by the PTO system 102 (via the PTO server 118). In some examples, the order matching engine may 126 route PTO orders to the one or more external systems 104 under one or more predefined conditions. In some examples, the order matching engine 126 may generate one or more transactions responsive to processing the PTO orders and may store the transaction(s) in the one or more databases 116.

The interactive GUI 120 may be configured to communicate with PTO server 118 and the one or more client applications and/or services 117. The interactive GUI 120 may be configured to generate one or more interactive presentations 122 for display on the one or more user devices 132 (e.g., that may be in communication with the one or more order systems 106). In an example, the one or more interactive presentations 122 may allow a requestor (e.g., associated with one of the requestor system(s) 130) to input information about a plurality of bonds, such as, for example, bond identifier (ID), size and direction (e.g., buy or sell), to create a group of bond orders. The one or more interactive presentations 122 may allow a selected recipient (e.g., associated with one of the responder system(s) 134) to view the group of bond orders, select individual bonds for a trade, and input a best price for the requestor to consider.

In an example, the interactive GUI 120 may update the one or more interactive presentations 122 in real time. In another example, the interactive GUI 120 may update the one or more interactive presentations 122 at predetermined intervals. The one or more interactive presentations 122 may be transmitted to the one or more requestor systems 130 and selected ones of the one or more responder systems 134 and then displayed on the one or more user devices 132. The interactive GUI 120 may relay the user input received from among the user devices 132 to the PTO server 118. In some examples, the one or more interactive presentations 122 may include different configurations for the requestor and the selected responders. In some examples, the one or more interactive presentations 122 may include different configurations depending on characteristics of the various responders that are selected, via the PTO server 118, to potentially participate in the PTO process.

In some examples, the one or more interactive presentations 122 may include different configurations based on an underlying application and/or service for which it is launched. For example, the interactive GUI 120 may have a first configuration for a mobile application, may have a second (different) configuration for a desktop application and may have a third (different) configuration for a spreadsheet application. In some examples, the one or more interactive presentations 122 may have different configurations.

The PTO system 102 may include one or more client applications and/or services 117 for creating one or more instances of application(s) and/or service(s) based on attributes of one or more of the one or more order systems 106 and the one or more user devices 132 (e.g., device type, screen size, etc.). For example, the one or more client applications and/or services 117 may create instances of one or more of a trading desktop, a spreadsheet application, a mobile application (e.g., an application that may be suitable for a display screen of a mobile device such as a tablet and/or smartphone) streaming (e.g. raw, normalized, filtered and/or aggregated) data feeds and/or one or more APIs for receiving data in one or more object-oriented programming languages (e.g., Java, Python™, R, etc.).

The PTO system 102 may include a client / server connection manager 128 (also referred to as connection manager 128) configured to manage client to server connection requests. In general, connection manager 128 may manage connection request(s) of the requester system 130 and the one or more responder systems 134 to the PTO system 102 (as well as the one or more order systems 106 generally) and coordinate with the one or more client applications and/or services 117.

Referring now to FIG. 1B, a functional block diagram of an example of the PTO server 118 is shown. The PTO server 118 may include a message parser 152, a validation engine 154, an optional rating engine 156, a timer engine 158, a message generator 160, and a message router 162.

The message parser 152 may be configured to parse incoming electronic message data from the one or more data caches 124. In an example, electronic messages may include a message header having a predetermined format and a message body. The message parser 152 may parse each message to identify and extract one or more predetermined elements in the message header (e.g., an element in a predetermined position, a flag set in a predetermined position and the like) associated with message characteristic(s). In some examples, the message parser 152 may parse information in the message body to extract one or more message characteristics (e.g., a requestor ID, a responder ID, bond ID, size, direction, etc.). For example, the message parser 152 may identify and extract keywords (e.g., “buy”, “sell”, etc.), predetermined phrases, etc. in the message body, via one or more text-parsing algorithms (e.g., keyword matching, natural language processing based on one or more rules, and the like). The extracted elements (e.g., message characteristic(s)) in the header and/or message body) may be stored in one or more of a PTO state database 164, a PTO historical database 166, and an optional ratings database 168 of the one or more databases 116. The PTO state database 164 may be configured to store one or more of PTO requests, PTO responses, and PTO orders. The PTO historical database 166 may be configured to store order execution details. The ratings database 168 may be configured to store one or more of requestor and/or responder rating information.

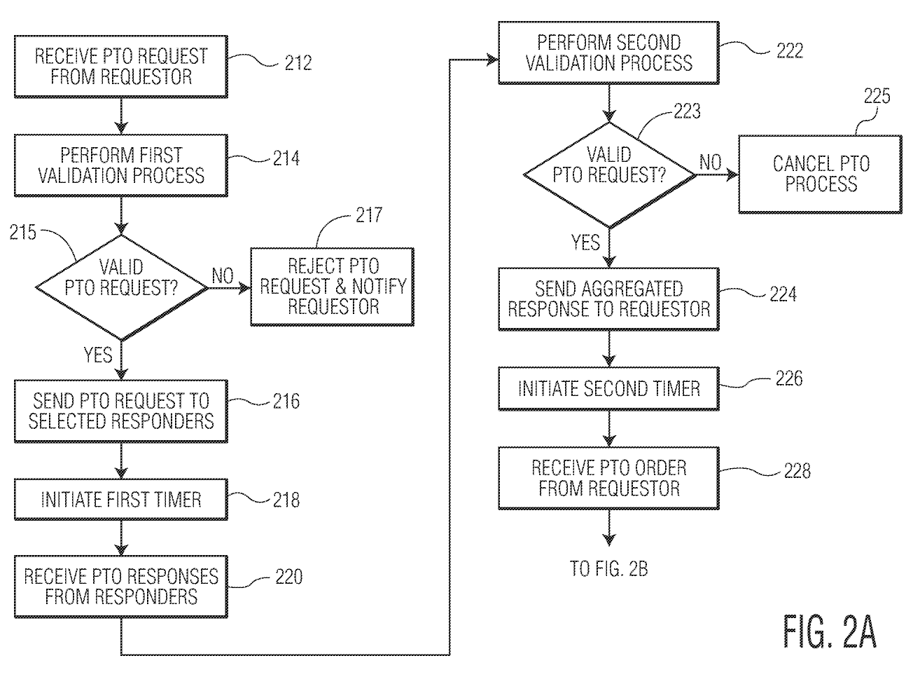

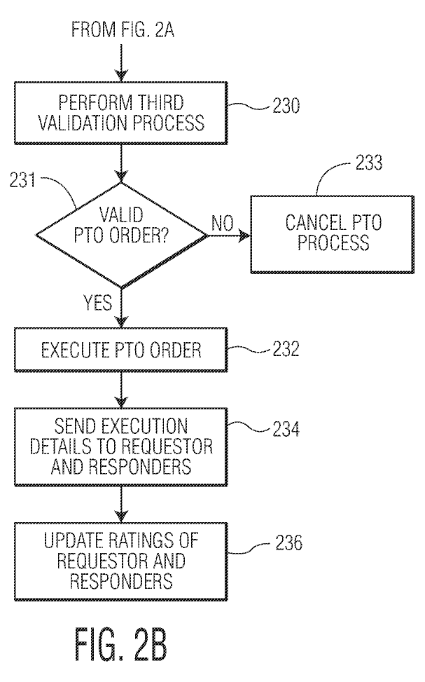

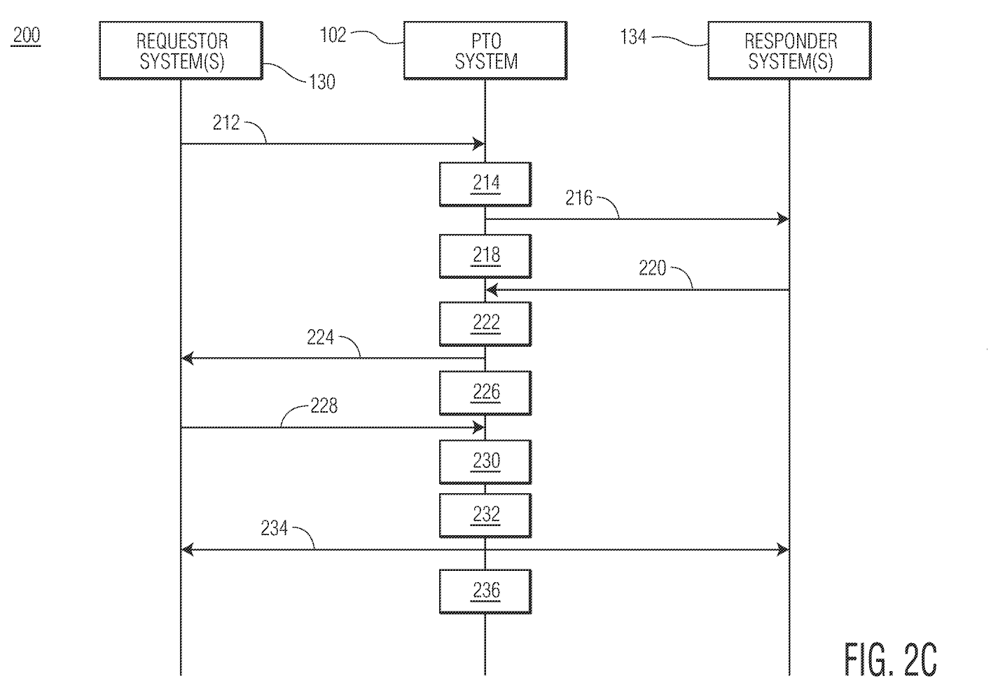

The validation engine 154 may be configured to perform one or more validation processes to determine whether messages stored in the PTO state database 164 by the message parser 152 are valid. Examples of a first validation process, a second validation process, and a third validation process that may be performed by the validation engine 154 are described in detail below with respect to FIGS. 2A and 2B. The validation engine 154 may be coupled to the order matching engine 126. For example, the validation engine 154 may submit a validated PTO order to the order matching engine 126 for execution (as described further below).

The ratings engine 156 may be configured to generate and maintain ratings for requestors and responders based on one or metrics associated with the PTO process. The rating of the requestor and the ratings of the one or more responders may be stored in the ratings database 168. The rating metrics generated by the ratings engine 156 may provide a clear, objective measure of trading participation and may help encourage requestors to actively engage in PTO transactions to maintain or improve their ratings. This may lead to increased liquidity and more efficient system functionality. For example, increased liquidity may lead to an increased likelihood of orders being executed and cleared from the PTO state database 164. Overall, the ratings metrics generated by the ratings engine 156 may promote active participation and reduce the number of did not trades (“DNTs”) indicators that may result when a trade inquiry does not result in an executed trade, thereby enhancing the overall efficiency and effectiveness of the PTO process over conventional portfolio trading.

The ratings metrics (e.g., a star rating) may also be used to incentivize the requestors to minimize “fishing,” which is a term for putting out requests, request for quotes (“RFQs”), list trades, portfolio trades, etc. and often not participating in trading, in order to obtain price information and gain sentiment knowledge about the market. Responders typically do not like this practice as it wastes their time and can give up valuable pricing information. The ratings metrics provided by the ratings engine 156 may also provide a record of the performance of the requestor. If a responder sees that a requestor has a 5-star rating (for example), they may submit a PTO response with more aggressive pricing. It should be noted that a 5-star rating would still allow for the occasional cancellation of a PTO request.

In some cases, a responder may need to cancel or break one of the orders within a PTO order due to human error or technology issues. The ratings engine 156 may produce a responder score for responders (responders) that reflects the percentage of volume they cancel or break after the PTO server 118 initiates execution of the approved orders in the PTO order. This score for each responder may be shown to requestors prior to selecting one or more responders while preparing the PTO request. This information may be useful as requestors may choose not to trade with particular participants that break trades too often.

In some examples, the ratings engine 156 may update the rating of a requestor based on traded volume divided by requested volume. In a non-limiting example, a requestor may receive a five-star rating (for example) if the total traded volume divided by the total requested volume for a previous predetermined number of PTO requests (for example, 20 PTO requests) is greater than a predetermined value (for example, greater than 90%). If less than the predetermined number of PTO requests (for example, less than 20 PTO requests) have been submitted, a running figure may be calculated based on all prior PTO requests for the requestor. In some examples, for canceled PTO requests, a value of $0 may be added to the numerator, and the total PTO request size may be added to the denominator for the calculation. As one non-limiting example, a four-star rating may be between 80% and 90%, a three-star rating may be between 70% and 80%, a two-star rating may be between 50% and 70%, a one-star rating may be less than 50%. Although the examples described above illustrate a star rating (e.g., 5-star, 4-star, 3-star, etc.), it is understood that the ratings engine 156 may generate any suitable metric(s), including, but not limited to a star rating to indicate objective ratings of requestors and responders with respect to their participation with PTO orders. Moreover, the ratings engine 156 provides unbiased (objective) metrics on requestors and responders based on their participation with PTO orders over time. A requestor or responder may improve (or diminish) their rating based on their own behavior with the PTO system 102 over time but may not otherwise influence the rating metrics of other participants (e.g., a responder may not provide a subjective, negative review of a particular requestor).

The timer engine 158 may set one or more timers having predetermined period(s) for use by the validation engine 154 in one or more of the first validation process, the second validation process, and the third validation process to determine whether messages stored in the PTO state database 164 by the message parser 152 are valid. In some examples, the predetermined time period(s) may depend on the particular validation process. In some examples, the predetermined time period(s) may be set by an administrator of the PTO system 102. In some examples, the predetermined time period(s) may be set by the particular requestor. In some examples, the predetermined time period(s) may be set based on market conditions and/or the particular bonds associated with the PTO request.

The message generator 160 may incorporate information from one or more of the validation engine 154, the ratings engine 156, and the timer engine 158 to generate secure electronic messages for transmission to one or more of the one or more requestor systems 130 (FIG. 1A) and the one or more responder systems 134 (FIG. 1A). In some examples, the electronic messages may be generated for transmission via the data interface 112. In some examples, the message generator 160 may interface with the interactive GUI 120 to incorporate message data into the one or more interactive presentations 122. In an example, the message generator 160 may aggregate message data from a plurality of messages stored in the PTO state database 164 by the message parser 152 based on one or more rules to generate a single aggregated message.

The message router 162 may be configured to direct outgoing messages to specific entities, such as the one or more requestor systems 130 and the one or more responder systems 134 selected by a requestor. In some examples, the message router 162 may direct the outgoing messages via the data interface 112 and/or the interactive GUI 120.

Referring now to FIGS. 2A, 2B and 2C, an example PTO process 200 is shown, according to an example of the present disclosure. In particular, FIGS. 2A and 2B are flow charts illustrating example PTO process 200; and FIG. 2C is a signal flow diagram illustrating the example PTO process 200, including a successful completion of the PTO process 200. Referring to FIGS. 2A and 2C, at step 212, the PTO system 102 (FIG. 1A) may receive a PTO request submitted by a requestor among the one or more requestor systems 130 as a secure electronic message.

The PTO request may be created by the requestor among the one or more requestor systems 130 (FIG. 1A) based on, for example, user input to a first interactive presentation of the one or more interactive presentations 122 (FIG. 1A) displayed on the one or more user devices 132 (FIG. 1A) that is associated with the requestor. In some examples, the requestor may select a plurality of bonds based on specific criteria such as (without being limited to) one or more of duration, credit rating, or sector exposure. For example, the requestor might select a mix of corporate bonds with varying maturities and credit ratings (for example, to diversify risk).

In some examples, contrary to a conventional portfolio trade, the requestor may trade a minimum threshold (volume) of bonds selected for the PTO request. Therefore, the requestor may choose some bonds besides their desired initial trading criterion, such as suitable alternatives with potentially improved pricing. For example, the requestor may identify 80 bonds to sell to rebalance a portfolio but may also choose another 20 bonds that serve as good alternatives for some of the initial 80 bonds. This optionality may allow the requestor to take advantage of pricing differences across the 100 bonds in the PTO request and trade the 80 bonds with the most favorable pricing, which may not be the same set as the initial 80 bonds. Alternatively, the requestor may opportunistically decide to sell 90 of the bonds if the pricing is aggressive.

Additional pricing information, beyond what the requestor decides to trade, may be very useful. For instance, the requestor may select a few illiquid bonds for the PTO request to use the executable prices in a vendor price challenge so that their official books and records may be more accurate. Ultimately, the construction of the PTO request and the process of choosing which minimum threshold to trade may provide significant value to the requestor in the form of better pricing, reduced information leakage, opportunistic trading with excess liquidity, and valuable executable prices. The bonds selected by the requestor may be bundled into a single basket for the PTO request. For example, the basket might include 100 different bond orders (e.g., of varying sizes), buy and sell orders, with a total face value of $100 million.

It should be noted that executable prices mean that the responder is firmly committed to trade at the price, whereas indicative pricing from responders in the form of indications of interest (IOI) are not firm or committed. Therefore, indicative pricing may be less valuable. Typically, responders post indications of interest (“IOIs”) on thousands of bonds throughout the day on multiple trading platforms. This pricing gives an indication but may not be as valuable as executable prices in the PTO process.

The bond orders may include (in a non-limiting example) bond ID, size, and direction (i.e., buy or sell). The requestor may put in a buy order and sell order for the same security but may be allowed to accept only one direction to trade. Rather than separately publishing individual requests for quotes (“RFQs”), the PTO process may be used for transacting multiple bond orders at once, which may increase efficiency in that all orders may be completed simultaneously instead of bit by bit over time. By completing all the orders at once, risk metrics of the portfolio (e.g., duration, sector percentage exposures, etc.) may be maintained at a target or moved to a new target as desired (for example, as directed by a portfolio administrator). For example, to keep the risk characteristics of a portfolio constant, a fund manager may need to buy an amount of each bond that keeps each bond’s portion of the portfolio constant. Likewise for a redemption, the fund manager may need to sell an amount of each bond that keeps each bond’s portion of the portfolio constant. For passive funds, the fund manager may need to match monthly index rebalancing, which may include buying or selling many bonds simultaneously. The PTO system 102 provides such a mechanism to do so.

In an example, the one or more requestor systems 130 may be one or more of an OMS and EMS that allows the requestor to manage the life of any PTO requests. The OMS may help track the PTO request from inception to settlement and may ensure the orders in the PTO request are compliant with any investment mandates. After the PTO request clears the OMS process, the OMS may send the PTO request (and associated orders) to the EMS, which then sends the PTO request (and associated orders), in step 212, to the PTO system 102. The secure electronic message(s) sending information associated with the PTO request (e.g., order details) and responses between OMS and/or EMS (in some examples), trading platform and responders may be sent via the FIX protocol. The FIX protocol may support multiple formats and types of communications between financial entities including trade allocation, order submissions, order changes, and execution reporting.

In an example, the PTO request (step 212) may be initiated at any desired time by the requestor during bond market hours. In another example, the PTO system 102 may have a scheduled period of time when PTO requests can occur (e.g., 10am and 2pm). A single requestor may initiate a few PTO requests a day but could conceivably initiate more (such as, without being limited to dozens). Since these orders are large and complex, there may be extensive analysis required. Responders may be able to participate in dozens of PTO requests a day. Unlike conventional portfolio trading, there may be no negotiation of PTO requests, so the number and volume of PTO requests in the market may exceed that of conventional portfolio trades.

The PTO request (step 212) may include a number of desired responders selected by the requestor. In a non-limiting example, a minimum of three responders (e.g., dealers) may be selected so that the requestor may obtain sufficient market participation and sufficient pricing, and to reduce the possibility of responder collusion. As discussed in detail below, the requestor and the one or more responders may each have ratings as determined by the ratings engine 156 (FIG. 1B). The PTO system 102 may store the PTO request in the PTO state database 164 (FIG. 1B).

In some examples, the first interactive presentation may include rating metrics (e.g., stored in ratings database 168) for various order entities among order systems 106. The requestor may select the one or more responder systems 134 based on the ratings metrics generated by the PTO system 102.

At step 214, the PTO system 102 may perform a first validation process to determine whether the PTO request is valid. The first validation process may be performed by the validation engine 154 (FIG. 1B). The first validation process may include determining if the PTO request meets one or more first validation conditions. In a non-limiting example, the first validation conditions may include one or more of a minimum order count, a minimum number of responders selected, a non-repeated order condition (e.g., no repeat orders with the same financial security identifier and direction (e.g., buy/sell)), a valid PTO minimum threshold acceptance amount (e.g. X% of PTO), and a PTO timer value (e.g., for responders to respond and for accepting any responses). In another example, the PTO minimum threshold acceptance amount may be a predetermined amount set by the PTO system 102. Responders may bid on each individual order in a PTO request (as compared to bidding on the entire basket in a portfolio trade procedure) so the minimum threshold may be a portion of the volume in the PTO. It should be noted that a minimum threshold may create an incentive for requestors to fish for price discovery, but the ratings metrics generated by the PTO system 102 itself (in particular by the ratings engine 156) rather than individual user feedback, may help reduce this incentive and keep dealer participation high for highly rated requestors.

The minimum threshold (among the first validation conditions), as part of PTO process 200 may reduce information leakage as compared to a fully disclosed trading intention with a conventional portfolio trade procedure. Because the requestor may trade the minimum threshold of orders within the PTO request, the true intent of the requestor may not be known as readily as in a portfolio trade, thus providing improved security. Although the selected responders may be able to make some inferences from the PTO request and order construction because of the condition to trade the minimum threshold (or cancel), the selected responders may not be able to ascertain the entire PTO request. In some examples, the requestor may use a few dozen orders for highly liquid bonds to bundle and ultimately mask the trading intentions for the illiquid bond. The reduction in information leakage may make the requestor more comfortable inviting an additional number of responders. The participation of an increased number of responders (e.g., increased market participation) may in turn lead to improved pricing. In addition, because several responders may absorb more risk than a single responder, PTO requests may be larger and still attract aggressive pricing.

At step 215, the PTO system 102 (e.g., the validation engine 154) may determine if the PTO request is valid based on the first validation process. At step 217, if one or more of the first validation condition checks fail, the PTO request may be determined to be invalid and may not be sent to any of the responders indicated in the PTO request. The PTO system 102 (at step 217) may send a secure electronic message to the particular requestor system 130 notifying the requestor that the PTO request is invalid.

At step 216, if the PTO request is determined to be valid (at step 215), the PTO system 102 may send the PTO request to the one or more responder systems 134 (FIG. 1) of the selected responders (indicated in the PTO request) via one or more secure electronic messages for display on the one or more user devices 132 (FIG. 1A).

The PTO request may be displayed on the one or more user devices 132 as a second interactive presentation of the one or more interactive presentations 122. The second interactive presentation may include (without being limited to) the bond ID, size, and direction (i.e., buy or sell) of the basket of bond orders. The PTO request displayed on the user devices 132 of the selected responders may also include a time period (e.g., a first predetermined time period) for responding to the PTO request. The second interactive presentation may also include an input portion configured to receive user input entered into the one or more user devices 132. The user input may include one or more of a best price.

In an example, the requestor’s identity may be included in the PTO request (at step 216) and therefore revealed to the invited selected responders. By indicating the requestor’s identity, the selected responders may be more responsive and provide more aggressive pricing for certain requestors (e.g., large asset managers who may be more likely to utilize the PTO process). Further, the selected responders may desire knowing the identity of the entity initiating the PTO process so they can consider any relationship aspects with the requestor. In another example, the requestor’s identity may not be included in the PTO request that is sent to the selected requestors (at step 216). The selected responders may respond to any or all orders in the PTO request within the first predetermined time period. In some examples, PTO system 102 may include one or more rating metrics associated with the requestor (e.g., stored in ratings database 168) as part of the PTO request that is presented to the selected responders.

At step 218, the PTO system 102 may start a first timer (e.g., via the timer engine 158) for a first predetermined time period in which the one or more (selected) responder systems 134 may provide a response to the PTO request. After the end of the first predetermined time period, the PTO system 102 may close the window for all responses (e.g., by preventing entry of any user input responses in the second interactive presentation of the selected responders. In a non-limiting example, the first predetermined time period may be 20 minutes, but any time period is contemplated.

At step 220, the PTO system 102 may receive one or more PTO responses from among the one or more responder systems 134 via one or more secure electronic messages. The one or more PTO responses may be stored in the PTO state database 164. In some examples, if the PTO system 102 does not receive any PTO responses within the first predetermined time period, the PTO system 102 may proceed to step 225 and cancel the PTO process.

At step 222, the PTO system 102 may perform a second validation process to determine whether each received PTO response (obtained at step 220 from among the selected responses) is valid. The second validation process may be performed by the validation engine 154 (FIG. 1B). The second validation process may include a first step and a second step. The first step (of the second validation process of step 222) may include (without being limited to) determining one or more of: that the particular responder was one of the selected responders invited by the requestor, that the PTO response was received prior to expiration of the first timer, and that the format of the best prices within the PTO response is valid. If any of the above checks are not met, the PTO response may be canceled at step 225 and removed from the PTO state database 164.

The second step (of the second validation process of step 222) may include (without being limited to) determining one or more of: that a minimum number of the received PTO order responses have at least one valid price (e.g., at least 90%), that a minimum number of the received PTO order responses have at least two valid prices (e.g., at least 80%), that a minimum number of the received PTO order responses have at least three valid prices (e.g., at least 50%), and that a minimum number of the received PTO responses have at least one valid price within a predefined range of an independent pricing source (e.g., at least 80%). If any of the above checks are not met, the PTO process may be canceled at step 225 and the PTO system 102 may send one or more secure electronic messages to the particular requestor system 130 and the one or more responder systems 134 with a notification of the cancellation.

In step 223, the PTO system 102 (e.g., validation engine 154) may determine if the PTO responses are valid based on a third step of the second validation process. The third step of the second validation process (at step 223) may be a pass-fail test that considers, for example, one or more of an average count of price responses for all orders, a percentage of orders with no price responses, and a percentage of orders with only one price response. For example, if the percentage of orders with no price responses is greater than a predetermined percentage (e.g., 10%), the PTO process may be automatically cancelled at step 225. In another example, if more than 20% of the orders have no price or only one price, the PTO process may be automatically cancelled at step 225. The automatic cancellation at step 225 may not affect a rating of the requestor, discussed in detail below.

At step 224, when the PTO responses are valid, the PTO system 102 may generate and send an aggregated PTO response via one or more secure electronic messages to the particular requestor system 130 that generated the PTO request (in step 212). The aggregated PTO response may include an aggregated best price for each bond order in the basket of bond orders from among the received PTO responses (step 220) across each of the selected responders. In an example, where there are two or more identical best prices for the same bond order, the PTO system 102 may initiate a protocol to select a single best price from the two or more identical best prices. The protocol may include selecting the single best price based on one or more additional criterium, including, but not limited to, an earlier time of receipt of the corresponding PTO response of the PTO responses and a rating of the responder associated with the corresponding PTO response.

The aggregated PTO response may be displayed on the corresponding user device 132 of the particular requestor (FIG. 1A) as a third interactive presentation of the one or more interactive presentations 122 (FIG. 1A). The third interactive presentation may provide information related to the aggregated PTO response including (without being limited to) the bond ID, size, and direction (i.e., buy or sell) of each bond order in the basket of bond orders as well as the best price. In addition, the third interactive presentation may include a time period (e.g., a second predetermined time period) for initiating a PTO order based on the aggregated PTO response. The third interactive presentation may include an input portion configured to receive user input from the requestor via the corresponding user device 132 (FIG. 1A). The user input may include a selection to accept or reject the best prices.

In an example, the aggregated PTO response generated by the PTO system 102 (and presented as part of the third interactive presentation) may mask the identity of the responders for each of the displayed best prices until the requestor accepts the best price. In another example, the identity of the responders may remain anonymous. If the requestor can see the responder information for orders that haven’t been committed to trade, there may be an incentive for the requestor to not accept the order in the aggregated PTO response and reach out to the responder directly to request improved pricing and trade the order away from the PTO system 102 (e.g., via outside communication means). By not revealing information regarding responder identities, the PTO process 200 may prevent such platform information leakage. In addition, by keeping the responder responses anonymous, trading decisions may be focused on best price. In contrast, with conventional portfolio trades, where the responders are known and negotiated with, price may be a secondary concern after first considering any relationship aspects with the counterparty. Therefore, the PTO process may provide an improved execution compliance protocol.

At step 226, the PTO system 102 may set a second timer (e.g., via timer engine 158) for a second predetermined time in which the requester system 130 may provide a response to the aggregated PTO response. After the second predetermined time period, the PTO system 102 may close the window for the requestor to provide a response (e.g., by preventing user input entry into the third interactive presentation for initiating a PTO order). In a non-limiting example, the second predetermined time period may be 20 minutes, but any suitable time period is contemplated.

During the second predetermined time period (at step 226), the requestor may accept or reject the best price for each bond order in the basket of bond orders, thereby creating a PTO order. The requestor may not be able to accept a buy order and sell order for the same security (e.g., they may choose one direction to trade each bond). Within the second predetermined time period, the requestor may execute the entire PTO order (e.g., hit “submit PTO” on the third interactive presentation of the interactive presentation 122) or terminate the entire PTO order (e.g., hit “cancel PTO” on the third interactive presentation).

At step 228, the PTO system 102 may receive the PTO order from the requestor of requestor system 130, within the second predetermined time, via one or more secure electronic messages. The received PTO order may be stored in the PTO state database 164. In some examples, if the PTO system 102 does not receive the PTO order (in step 228) within the second predetermined time period, the PTO system 102 may proceed to step 233 and cancel the PTO process.

Referring to FIGS. 2B and 2C, at step 230, the PTO system 102 may perform a third validation process to determine whether the received PTO order is valid. The third validation process may be performed by the validation engine 154 (FIG. 1B). The third validation process may include (without being limited to) determining one or more of: that the PTO order was received prior to expiration of the second timer and that a minimum threshold of best prices for bond orders (e.g., at least 80%) was accepted by the requestor. Any other suitable PTO order validation condition is also contemplated.

At step 231, the PTO system 102 may determine if the PTO order is valid based on the third validation process. At step 233, if any of the above PTO order validation condition checks are not met, the PTO process may be canceled at step 233 and the PTO system 102 may send one or more secure electronic messages to the requester system 130 and the one or more responder systems 134 with a notification of the cancellation.

At step 232, if the PTO order is valid, the PTO system 102 may initiate an execution process for the accepted orders within the PTO order. For example, the order matching engine 126 (FIG. 1B) may receive a confirmation from the validation engine 154 and may retrieve the validated PTO order from the PTO state database 164 and may execute the PTO order. In some examples, the order matching engine 126 may generate one or more electronic messages containing information associated with the PTO order and send the one or more electronic messages to the data interface 112 (FIG. 1B) for transmission to the one or more external systems 104 (FIG. 1A) via the one or more networks 110 for processing.

For example, the PTO system 102 may send one or more of the bond ID, volume, price, settlement date (e.g., timestamp), and counterparty to one or more of a bond trading platform and a trade capture system to confirm the trade terms. The trade capture system may send information associated with the trade to one or more of a compliance system and a risk management system to verify regulatory compliance and risk limits. The results may be returned to the trade capture system. The trade capture system may retrieve details about the requestor and responder and settlement instructions (e.g., from the PTO system 102 and/or the one or more order systems 106 (FIG. 1A)), append them to a trade record, and complete the trade data for processing and reporting.

The trade capture system may format trade details per regulatory requirements and may send them to a trade reporting system. The trade reporting system may submit the trade details to a relevant trade repository or regulator via API or standardized format (e.g., XML, etc.). This may occur in real-time or within a mandated timeframe (e.g., T+1 or 15 minutes). This may fulfill regulatory obligations for transparency (e.g., price, volume, and counterparty). Enriched trade data, including reporting confirmation, may be sent from the trade capture system to one or more of the PTO system 102 and/or the one or more order systems 106. The trade details may be recorded as a pending transaction in a general ledger.

Settlement instructions (e.g., payment, delivery details) may be sent to a custodian via. The custodian may hold the securities on behalf of the asset manager and ensure proper settlement of the trade. Post-settlement, the custodian may confirm completion and send execution details to the PTO system 102. The PTO system 102 may store the order execution details in the PTO historical database 166.

At step 234, the PTO system 102 may send the order execution details simultaneously to both the requestor system 130 associated with the PTO order and the one or more responder systems 134 that participated in the PTO process. The order execution details may be sent in one or more secure electronic messages. In an example, the identity of the requestor may be disclosed to the responders. In another example, the identity of the requestor may be withheld from the one or more responders. In an example, the one or more responders’ identities may be disclosed to the requestor. In another example, the one or more responders’ identities may be withheld from the requestor.

In some examples, the order execution details may inform the one or more responders in which of the orders in the PTO order their price represented the best price and the cover (i.e., second best price) regardless of whether the order was accepted by the requestor. This data may be valuable for the responders to recalibrate their pricing models. In some examples, the responders may report the trades to one or more reporting entities, for example, to the Financial Industry Regulatory Authority (“FINRA”).

In some examples, each responder may not be notified of other responders being invited during the PTO process and/or in post-trade reporting, so that all responders may be blind to each other. Such participation secrecy may keep the PTO process competitive. This participation secrecy may also be desirable to responders.

In some examples, in post-trade reporting, responders may be notified of any orders in the PTO order for which they were selected for execution, on which they were the cover (i.e., a second best price), and for which orders that are not traded where they were best and cover. In some examples, as an award for aggressive pricing (e.g., being first or second for an order in the PTO order), the post-trade reporting may also include the total count of price responses for the order and/or metrics describing the distribution of the prices (e.g., high, low, average, standard deviation, etc.). This price distribution information may be valuable for the responders and may encourage their participation in future PTO requests. Responders may desire pricing information to prepare for future trades. If the PTO process is canceled, responders may still learn where they were best and second best on all orders, which may still be a reward for their participation.

In some examples, the requestor may receive responder information for each accepted/executed order. Responder information may not be disclosed for declined orders. In some examples, requestors may not receive responder information if the PTO process is cancelled or fails to meet the minimum accepted volume threshold. In this manner, the responders may be protected from releasing attributed pricing information without getting the reward of trading. Further, this may protect the platform from having a requestor and a responder doing unilateral trades away from the platform (e.g., via chatting) after the completion of the PTO process. Post-trade reporting may provide the requestor with a number of price responses from each responder as well as the number of times they were the winner and cover. This information may be valuable for the buy-side to measure the liquidity that the responders are providing. In some examples, any prices below the best price by a predetermined percentage may be excluded so that responders may not be able to take advantage of offering non-competitive prices. In some examples, periodic (e.g., monthly) post trade reports may be provided to the requestors and/or responders which aggregate PTO performance statistics.

Since requestors, in the PTO process, are likely to invite many responders and because the prices may be provided anonymously, there may be a high level of confidence that the requestor achieved the best price and not an inferior price in order to trade based on relationship with a responder. Further, post-trade reporting for the requestor may show how many prices they receive for each order that was executed, which may support best execution compliance protocols. The PTO system 102 may store the order execution details in the PTO historical database 166 (FIG. 1B)

At step 236, the PTO system 102 (e.g., ratings engine 156) may update the rating of the requestor and the ratings of the one or more responders based on information associated with the order execution details.

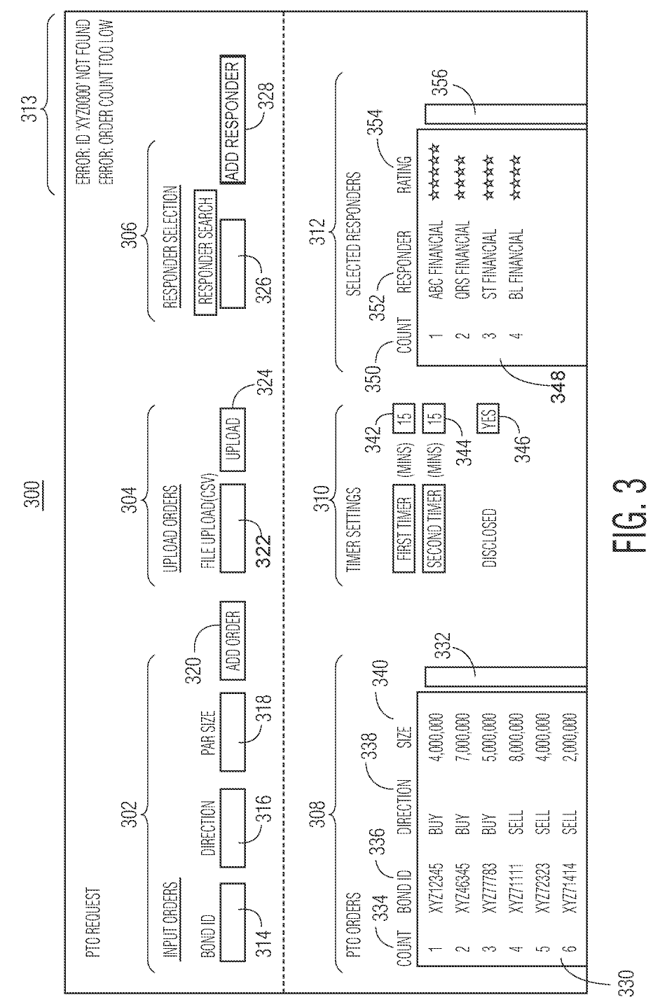

Referring now to FIG. 3, a diagram illustrating an example of the first interactive presentation 300 of the one or more interactive presentations 122 (FIG. 1A) is shown. The first interactive presentation 300 may be used by the requestor to generate the PTO request (e.g., step 212 in FIG. 2A). The first interactive presentation 300 may include an order input region 302, an order upload region 304, a responder selection region 306, a PTO orders region 308, a timer settings region 310, and a selected responders region 312.

The order input region 302 may include one or more text input regions, such as a bond identifier field 314 that may allow the requestor to manually enter a bond identifier, a direction field 316 that may allow the requestor to manually enter a direction (e.g., buy or sell), and a size field 318 that may allow the requestor to manually enter a size. In another example, one or more of the bond identifier field 314, the direction field 316, and the size field 318 may include a drop down menu (not shown). Once the bond identifier, direction, and size are entered by the requestor, the requestor may create a bond order by selecting an add order button 320.

The order upload region 304 may allow the requestor to upload a file (e.g., a csv file) that contains information for a plurality of orders, thereby incorporating information for the plurality of bond orders via a single step. A file upload field 322 may allow the requestor to manually enter a file name. In another example, the file name may be selected via a file browser window (not shown) or a drop down menu (not shown). Once a file is selected, the requestor may create one or more bond orders by selecting an upload button 324. The PTO system 102 may be configured to receive any conventional file type used for listing tradeable instruments, which may be in any number of formats. The PTO system 102 may reformat the file to a standard format for the one or more bond orders.

The responder selection region 306 may allow the requestor to select one or more responders to receive the PTO request. A responder search field 326 may allow the requestor to manually enter a responder. A responder name may autocomplete as the requestor enters text. In another example, the responder name be selected via a drop down menu (not shown). Once a responder name is selected, the requestor may add the responder via an add responder button 328.

The PTO orders region 308 may include a basket of bonds 330 selected by the requestor via one or more of the order input region 302 and the order upload region 304. A scroll bar 332 may allow the requestor to navigate the basket of bonds 330. The basket of bonds 330 may include a plurality of bond orders, each comprising a count 334, a bond ID 336, a direction 338, and a size 340.

The timer settings region 310 may allow the requestor to set one or more of the first timer (e.g., step 218 in FIG. 2C) via a first predetermined time field 342 and the second timer (e.g., step 226 in FIG. 2C) via a second predetermined time field 344. The first predetermined time field 342 and the second predetermined time field 344 may allow the requestor to manually enter respective times. In another example, the respective times may be selected via a drop down menu (not shown). The timer settings region 310 may also include a disclosure field 346 that allows a requestor to select whether or not one or more of the first timer and the second timer is disclosed to the selected responders. In another example, one or more of the first timer and the second timer may be set automatically by the PTO system 102.

The selected responders region 312 may include a selected responders list 348. The selected responders list 348 may include a count 350, a responder name 352, and a rating 354 for each of the selected responders. A scroll bar 356 may allow the requestor to navigate the selected responders list 348. In an example, the first interactive presentation 300 may also include an errors region 313 in which one or more error alerts may be displayed.

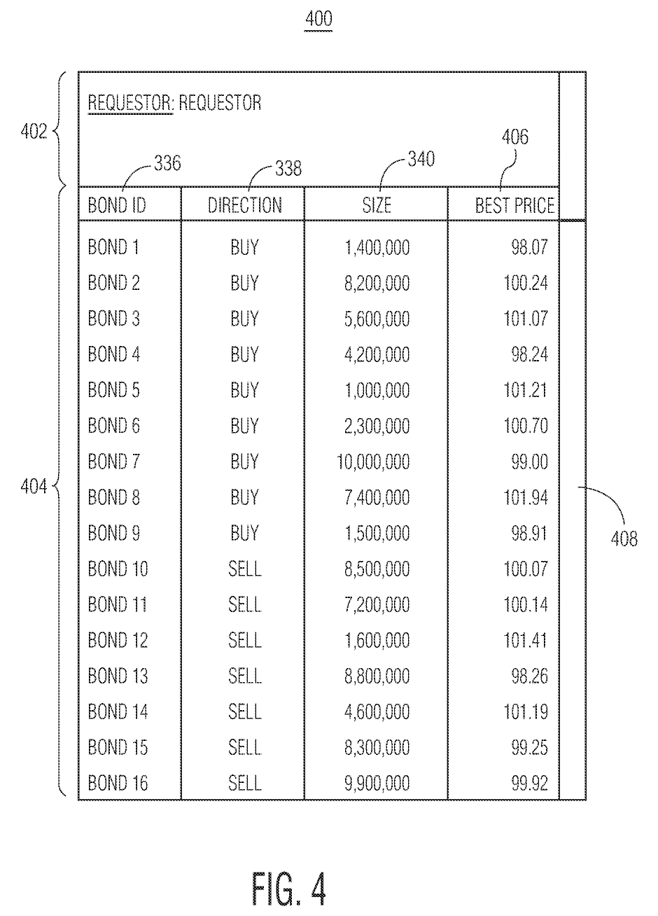

Referring now to FIG. 4, a diagram illustrating an example of the second interactive presentation 400 of the one or more interactive presentations 122 (FIG. 1A) is shown. The second interactive presentation 400 may be an example of a PTO response that may be generated by a particular (individual) responder (e.g., at step 220 in FIG. 2A). The second interactive presentation 400 may include a requestor identification region 402 and a responder bond order region 404. The responder bond order region 404 may include each bond order of the basket of bonds 330 (FIG. 3). The responder bond order region 404 may list the bond ID 336, the direction 338, and the size 340 of each bond order. The responder bond order region 404 may also include a best price field 406 for each bond order. The best price field 406 may allow the respective responder to manually enter a best price for one or more bond orders. In another example, the best price may be selected via a drop down menu (not shown). A scroll bar 408 may allow the requestor to navigate the responder bond order region 404.

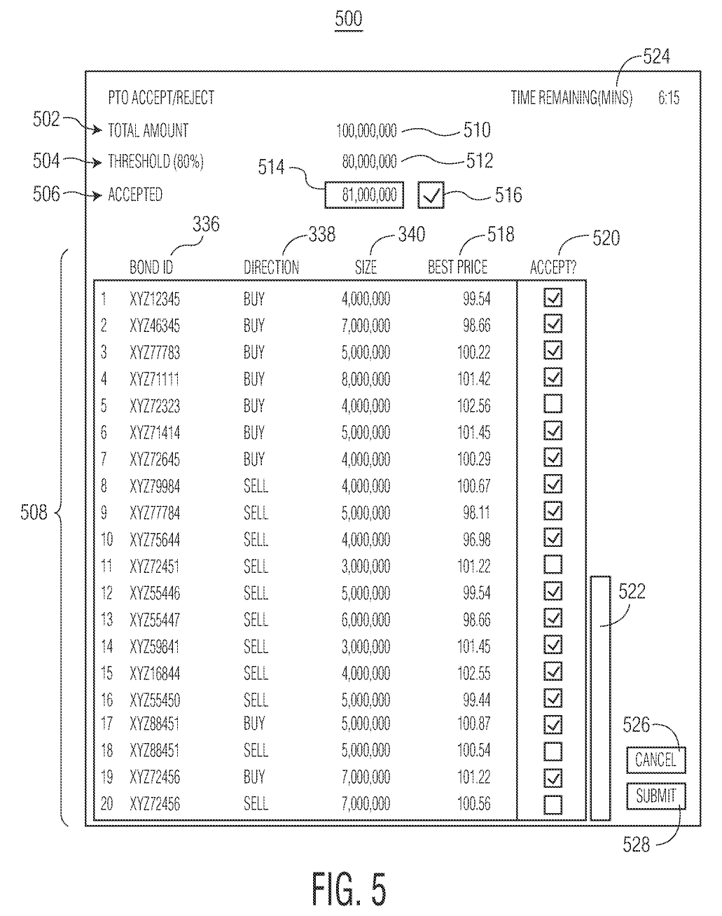

Referring now to FIG. 5, a diagram illustrating the third interactive presentation 500 of the one or more interactive presentations 122 (FIG. 1A) is shown. The third interactive presentation 400 may be an example of an aggregated PTO response that may be sent to the requestor by the PTO system 102 (e.g., at step 224 in FIG. 2A). The third interactive presentation 500 may include a total amount region 502, a threshold region 504, an accepted region 506, a requestor bond order region 508, and a time remaining region 524.

The total amount region 502 may display a total size 510 of all bond orders in the requestor bond order region 508, which may correspond to the basket of bonds 330 (FIG. 3). The total size 510 may be determined by summing the size 340 of each bond order. The threshold region 504 may display the minimum threshold acceptance amount 512. The minimum threshold acceptance amount 512 may be displayed as a volume. The accepted region 506 may display an accepted volume 514. Once the accepted volume 514 exceeds the minimum threshold acceptance amount 512, an alert may be displayed. The alert may include (without being limited to) highlighting (e.g., via color) the accepted volume 514 and/or the display of a separate indication 516.

The requestor bond order region 508 may list the bond ID 336, the direction 338, and the size 340 of each bond order. The requestor bond order region 508 may display the aggregated best price 518 from amongst all of the responders who submitted a PTO response. The requestor bond order region 508 may also include an acceptance button 520 for each bond order. If a requestor selects the acceptance button 520 for a bond order, the size of that bond order is included in the accepted volume 514, which may be updated in real time. A scroll bar 522 may allow the requestor to navigate the requestor bond order region 508.

The time remaining region 524 may display, in real time, an amount of time left in the second timer (e.g., step 226 in FIG. 2C). The requestor may cancel the PTO process at any time via a cancel button 526. Once the accepted volume 514 is more than the minimum threshold acceptance amount 512, the requestor may submit the PTO order via a submit button 528.

Unlike a conventional portfolio trade, there may be no direct communication between the requestor and the one or more responders during the PTO process. Accordingly, there may be no negotiated changes to the composition of the basket of bonds or the prices for the orders. All prices in the PTO process may be final and executable.

The PTO process of the present disclosure may reduce platform leakage. For example, the PTO process may not provide any counterparty discovery until after the trade decisions have been made. And discovery may only be made, for example, for the orders that trade. In addition, there may be no discovery for orders within a PTO request that do not trade.

The PTO process may also eliminate the need for extensive negotiation of basket composition and pricing across multiple participants (e.g., dealers) as compared to a portfolio trade. Thus, the PTO process may be more efficient and faster than a portfolio trade process and may significantly reducing messaging overhead. For example, from initiation to completion, the PTO process may take approximately 20-40 minutes if participants are given 20 minutes to respond to a PTO request and requestors are given 20 minutes to decide. In contrast, typical portfolio trades take at least 1 hour but may often take about 2-4 hours to complete because of the negotiation of the basket composition and price across multiple participants.

In addition to the technical improvements described above, the PTO platform 100 and the PTO process described herein may provide requestors with better pricing (e.g., the best price for each bond order in the aggregated PTO response may be superior to the best dealer for all bonds and the requestor may be able to reject individual bond orders based on pricing); extra liquidity, which may enhance the bond selection process with executable pricing; less information leakage as true intent may be masked, more dealer participation (e.g., because of the reduced less information leakage), valuable price discovery (e.g., on less liquid bonds), and a compliance friendly protocol where best price may drive the execution. In addition, the PTO platform 100 and the PTO process may provide responders with the ability to selectively offer prices for individual bond orders, which may help manage overall pricing and portfolio balancing, faster trading, protection of pricing and identity, and higher bond trading volumes.

Further, the PTO platform 100 and the PTO process may provide several benefits over the technology as a whole (i.e., conventional portfolio trading processes that use conventional trading systems). For example, the PTO platform 100 and the PTO process may provide faster electronic trading as it eliminates negotiation and/or modification of baskets and the back-and-forth communications through unsecured third-party messaging (e.g., instant messaging, text messaging, telephone). The PTO platform 100 and the PTO process may allow for higher volume trading, more price discovery, less information leakage, and more market liquidity.

Some portions of the present disclosure describe embodiments in terms of algorithms and/or routines and symbolic representations of operations on information. These algorithmic descriptions and representations are used to convey the substance of this disclosure effectively to others skilled in the art. These operations, while described functionally, computationally, or logically, are to be understood as being implemented by data structures, computer programs or equivalent electrical circuits, field programmable gate arrays (FPGAs), microcode, or the like. Furthermore, at times, it may be convenient to refer to these arrangements of operations as routines or algorithms. The described operations and their routines / algorithms may be embodied in specialized software, firmware, specially-configured hardware or any combinations thereof.

The methods described herein may be performed by processing logic that may comprise hardware (e.g., circuitry, dedicated logic, programmable logic, microcode, etc.), software (such as instructions run on a processing device), or a combination thereof. In one embodiment, the methods described herein may be performed by one or more specialized processing components.

Systems and methods of the present disclosure may include and/or may be implemented by one or more specialized computers including specialized hardware and/or software components. For purposes of this disclosure, a specialized computer may be a programmable machine capable of performing arithmetic and/or logical operations and specially programmed to perform the functions described herein. In some embodiments, computers may comprise processors, memories, data storage devices, and/or other commonly known or novel components. These components may be connected physically or through network or wireless links. Computers may also comprise software which may direct the operations of the aforementioned components. Computers may be referred to as servers, personal computers (PCs), mobile devices, and other terms for computing / communication devices. For purposes of this disclosure, those terms used herein are interchangeable, and any special purpose computer particularly configured for performing the described functions may be used.

Computers may be linked to one another via one or more networks. A network may be any plurality of completely or partially interconnected computers wherein some or all of the computers are able to communicate with one another. It will be understood by those of ordinary skill that connections between computers may be wired in some cases (e.g., via wired TCP connection or other wired connection) or may be wireless (e.g., via a WiFi network connection). Any connection through which at least two computers may exchange data can be the basis of a network. Furthermore, separate networks may be able to be interconnected such that one or more computers within one network may communicate with one or more computers in another network. In such a case, the plurality of separate networks may optionally be considered to be a single network.

The term “computer” shall refer to any electronic device or devices, including those having capabilities to be utilized in connection with an electronic information / transaction system, such as any device capable of receiving, transmitting, processing and/or using data and information. The computer may comprise a server, a processor, a microprocessor, a personal computer, such as a laptop, palm PC, desktop or workstation, a network server, a mainframe, an electronic wired or wireless device, such as for example, a telephone, a cellular telephone, a personal digital assistant, a smartphone, an interactive television, such as for example, a television adapted to be connected to the Internet or an electronic device adapted for use with a television, an electronic pager or any other computing and/or communication device.

The term “network” shall refer to any type of network or networks, including those capable of being utilized in connection with the systems and methods described herein, such as, for example, any public and/or private networks, including, for instance, the Internet, an intranet, or an extranet, any wired or wireless networks or combinations thereof.

The term “computer-readable storage medium” should be taken to include a single medium or multiple media that store one or more sets of instructions. The term “computer-readable storage medium” shall also be taken to include any medium that is capable of storing or encoding a set of instructions for execution by the machine and that causes the machine to perform any one or more of the methodologies of the present disclosure.

Referring now to FIG. 6, a functional block diagram of a machine in the example form of computer system 600 within which a set of instructions for causing the machine to perform any one or more of the methodologies, processes or functions discussed herein may be executed. In some examples, the machine may be connected (e.g., networked) to other machines as described above. The machine may operate in the capacity of a server or a client machine in a client-server network environment, or as a peer machine in a peer-to-peer (or distributed) network environment. The machine may be any special-purpose machine capable of executing a set of instructions (sequential or otherwise) that specify actions to be taken by that machine for performing the functions describe herein. Further, while only a single machine is illustrated, the term “machine” shall also be taken to include any collection of machines that individually or jointly execute a set (or multiple sets) of instructions to perform any one or more of the methodologies discussed herein. In some examples, one or more of components may be implemented by a specialized machine, particularly programmed to perform certain functions, such as the example machine shown in FIG. 6 (or a combination of two or more of such machines). In some examples, one or more of components 112-128 of the PTO system 102, the one or more external systems 104, the one or more order systems 106 and the one or more user devices 132 may be implemented by a specialized machine, particularly programmed to perform certain functions, such as the example machine shown in FIG. 6 (or a combination of two or more of such machines).

The example computer system 600 may include processing device 602, memory 606, data storage device 610 and communication interface 612, which may communicate with each other via data and control bus 618. In some examples, computer system 600 may also include display device 614 and/or user interface 616.

Display device 614 may be any known display technology, including but not limited to display devices using Liquid Crystal Display (LCD) or Light Emitting Diode (LED) technology.

The processing device 602 may use any known processor technology, including but not limited to graphics processors and multi-core processors. The processing device 602 may include, without being limited to, a microprocessor, a central processing unit, an application-specific integrated circuit (ASIC), a field programmable gate array (FPGA), a digital signal processor (DSP) and/or a network processor. The processing device 602 may be configured to execute processing logic 604 for performing the operations described herein. The processing device 602 may include a special-purpose processing device specially programmed with processing logic 604 to perform the operations described herein.

The memory 606 may include, for example, without being limited to, at least one of a read-only memory (ROM), a random access memory (RAM), a flash memory, a dynamic RAM (DRAM) and a static RAM (SRAM), storing computer-readable instructions 608 executable by processing device 602. The memory 606 may include a non-transitory computer readable storage medium storing computer-readable instructions 608 executable by processing device 602 for performing the operations described herein. Although one memory 606 is illustrated in FIG. 6, in some examples, computer system 600 may include two or more memory devices (e.g., dynamic memory and static memory).

The user interface 616 may be any known input device technology, including but not limited to a keyboard (including a virtual keyboard), mouse, track ball, camera, and touch-sensitive pad or display.

The data and control bus 618 may be any known internal or external bus technology, including but not limited to industry standard architecture (ISA), extended ISA (EISA), peripheral component interconnect (PCI), PCI Express, universal serial bus (USB), Serial advanced technology attachment (ATA) or FireWire.

The computer system 600 may include communication interface 612, for direct communication with other computers (including wired and/or wireless communication) and/or for communication with a network. In some examples, computer system 600 may include display device 614 (e.g., a liquid crystal display (LCD), a touch sensitive display, etc.).

In some examples, the computer system 600 may include data storage device 610 storing instructions (e.g., software) for performing any one or more of the functions described herein. Data storage device 610 may include a non-transitory computer-readable storage medium, including, without being limited to, solid-state memories, optical media and magnetic media.

One or more features or steps of the disclosed embodiments may be implemented using an application programming interface (API). An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

The methods described herein, including those with reference to one or more flowcharts, may be performed by a controller and/or processing device (e.g., smartphone, computer, etc.). The methods may include one or more operations, functions, or actions as illustrated in one or more of blocks. Although the blocks are illustrated in sequential order, these blocks may also be performed in parallel, and/or in a different order than the order disclosed and described herein. Also, the various blocks may be combined into fewer blocks, divided into additional blocks, and/or removed based upon a desired implementation. Dashed lines may represent optional and/or alternative steps.

Additional examples of the presently described method and device embodiments are suggested according to the structures and techniques described herein. Other non-limiting examples may be configured to operate separately or may be combined in any permutation or combination with any one or more of the other examples provided above or throughout the present disclosure. Components and/or arrangement of components illustrated in one figure may be incorporated into any other figure.

While the present disclosure has been discussed in terms of certain embodiments, it should be appreciated that the present disclosure is not so limited. The embodiments are explained herein by way of example, and there are numerous modifications, variations and other embodiments that may be employed that would still be within the scope of the present disclosure.

It will be appreciated by those skilled in the art that the present disclosure may be embodied in other specific forms without departing from the scope thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The terms “including” and “comprising” should be interpreted as meaning “including, but not limited to.” If not already set forth explicitly in the claims, the term “a” should be interpreted as “at least one” and the terms “the, said, etc.” should be interpreted as “the at least one, said at least one, etc.”

The present disclosure is described with reference to block diagrams and operational illustrations of methods and devices. It is understood that each block of the block diagrams or operational illustrations, and combinations of blocks in the block diagrams or operational illustrations, may be implemented by means of analog or digital hardware and computer program instructions. These computer program instructions may be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks may occur out of the order noted in the operational illustrations. For example, two blocks shown in succession may be executed substantially concurrently or the blocks may sometimes be executed in the reverse order, depending upon the functionality/acts involved.

For the purposes of this disclosure a non-transitory computer readable medium (or computer-readable storage medium/media) stores computer data, which data may include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, cloud storage, magnetic cassettes, magnetic tape, magnetic disk storage or other magnetic storage devices, or any other physical or material medium which may be used to tangibly store the desired information or data or instructions and which may be accessed by a computer or processor.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

It is the Applicant’s intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A system for electronic transaction processing, the system comprising:
a processor operatively coupled to a memory configured to store computer readable instructions that, when executed by the processor, cause the processor to:
receive, via a communications interface, a request for a multi-component electronic transaction comprising a plurality of components from a requestor system, the request generated based on user input to a first interactive presentation displayed on an interactive graphical user interface (“GUI”) of the requestor system and identifying a plurality of selected responders;
perform a first validation process on the request;
transmit, via the communications interface, the request to one or more responder systems associated with the plurality of selected responders;
receive, via the communications interface, one or more responses from among the one or more responder systems before expiration of a first predetermined time period, the one or more responses including one or more values for at least a portion of the plurality of components, the one or more responses generated based on user input to a second interactive presentation displayed on a respective interactive GUI of the one or more responder systems;
perform a second validation process on the one or more responses;
generate an aggregated response comprising a value of the one or more values for each component of the plurality of components, the value meeting a predetermined characteristic;
transmit, via the communications interface, the aggregated response to the requestor system;
receive, via the communications interface, an authorized transaction from the requestor system before expiration of a second predetermined time period, the authorized transaction generated based on user input to a third interactive presentation displayed on the interactive GUI of the requestor system;
automatically initiate an execution process for the authorized transaction responsive to a third validation process, the execution process comprising sending one or more electronic messages to one or more external systems via the communications interface;
receive, via the communications interface, order execution details from an external system of the one or more external systems; and
transmit, via the communications interface, the order execution details to the requestor system and the one or more responder systems.

2. The system of claim 1, wherein an identity of the requestor system is anonymous in the request.

3. The system of claim 1, wherein an identity of a selected responder of the plurality of selected responders associated with the value of the one or more values for each component of the plurality of components is anonymous in one or more of the aggregated response and the order execution details.

4. The system of claim 1, wherein one or more of an identity of the requestor system and an identity of a selected responder of the plurality of selected responders associated with the value of the one or more values for each component of the plurality of components is revealed in the order execution details.

5. The system of claim 1, wherein first validation process comprises:
determining one or more of: a number of the plurality of components is above a minimum, a number of the one or more responder systems is above a minimum, at least one of the plurality of components are not repeated, the request includes a valid minimum threshold acceptance amount, and the request includes a selection of the first predetermined time period.

6. The system of claim 1, wherein the second validation process comprises:
determining a response of the one or more responses was received from a selected responder of the plurality of selected responders and a format of the one or more values is valid.

7. The system of claim 1, wherein the user input to the third interactive presentation comprises a selection of yes or no to the value of the one or more values for each component of the plurality of components.

8. The system of claim 7, wherein the third validation process comprises:
determining a number of the plurality of components having a yes selection for the value meets a minimum threshold.

9. The system of claim 1, wherein each component of the plurality of components is a bond order comprising one or more of an identification of a bond, a size, and a direction.

10. The system of claim 1, wherein the processor is further configured to:
determine a rating of one or more of the requestor system and each selected responder of the plurality of selected responders based on one or more metrics associated with previous transactions; and
update the rating of one or more of the requestor system and each selected responder of the plurality of selected responders based on the order execution details.

11. A method for electronic transaction processing, the method comprising:
receiving, via a communications interface, a request for a multi-component electronic transaction comprising a plurality of components from a requestor system, the request generated based on user input to a first interactive presentation displayed on an interactive graphical user interface (“GUI”) of the requestor system and identifying a plurality of selected responders;
performing a first validation process on the request;
transmitting, via the communications interface, the request to one or more responder systems associated with the plurality of selected responders;
receiving, via the communications interface, one or more responses from among the one or more responder systems before expiration of a first predetermined time period, the one or more responses including one or more values for at least a portion of the plurality of components, the one or more responses generated based on user input to a second interactive presentation displayed on a respective interactive GUI of the one or more responder systems;
performing a second validation process on the one or more responses;
generating an aggregated response comprising a value of the one or more values for each component of the plurality of components, the value meeting a predetermined characteristic;
transmitting, via the communications interface, the aggregated response to the requestor system;
receiving, via the communications interface, an authorized transaction from the requestor system before expiration of a second predetermined time period, the authorized transaction generated based on user input to a third interactive presentation displayed on the interactive GUI of the requestor system;
automatically initiating an execution process for the authorized transaction responsive to a third validation process, the execution process comprising sending one or more electronic messages to one or more external systems via the communications interface;
receiving, via the communications interface, order execution details from an external system of the one or more external systems; and
transmitting, via the communications interface, the order execution details to the requestor system and the one or more responder systems.

12. The method of claim 11, wherein an identity of the requestor system is anonymous in the request.

13. The method of claim 11, wherein an identity of a selected responder of the plurality of selected responders associated with the value of the one or more values for each component of the plurality of components is anonymous in one or more of the aggregated response and the order execution details.

14. The method of claim 11, wherein one or more of an identity of the requestor system and an identity of a selected responder of the plurality of selected responders associated with the value of the one or more values for each component of the plurality of components is revealed in the order execution details.

15. The method of claim 11, wherein first validation process comprises:
determining one or more of a number of the plurality of components is above a minimum, a number of the one or more responder systems is above a minimum, at least one of the plurality of components are not repeated, the request includes a valid minimum threshold acceptance amount, and the request includes a selection of the first predetermined time period.

16. The method of claim 11, wherein the second validation process comprises:
determining a response of the one or more responses was received from a selected responder of the plurality of selected responders and a format of the one or more values is valid.

17. The method of claim 11, wherein the user input to the third interactive presentation comprises a selection of yes or no to the value of the one or more values for each component of the plurality of components.

18. The method of claim 17, wherein the third validation process comprises:
determining a number of the plurality of components having a yes selection for the value meets a minimum threshold.

19. The method of claim 11, wherein each component of the plurality of components is a bond order comprising one or more of an identification of a bond, a size, and a direction.

20. The method of claim 11, further comprising:
determine a rating of one or more of the requestor system and each selected responder of the plurality of selected responders based on one or more metrics associated with previous transactions; and
update the rating of one or more of the requestor system and each selected responder of the plurality of selected responders based on the order execution details.

21. A non-transitory computer readable storage medium configured to store one or more programs comprising computer readable instructions that, when executed by a processor, cause the processor to:
receive, via a communications interface, a request for a multi-component electronic transaction comprising a plurality of components from a requestor system, the request generated based on user input to a first interactive presentation displayed on an interactive graphical user interface (“GUI”) of the requestor system and identifying a plurality of selected responders;
perform a first validation process on the request;
transmit, via the communications interface, the request to one or more responder systems associated with the plurality of selected responders;
receive, via the communications interface, one or more responses from among the one or more responder systems before expiration of a first predetermined time period, the one or more responses including one or more values for at least a portion of the plurality of components, the one or more responses generated based on user input to a second interactive presentation displayed on a respective interactive GUI of the one or more responder systems;
perform a second validation process on the one or more responses;
generate an aggregated response comprising a value of the one or more values for each component of the plurality of components, the value meeting a predetermined characteristic;
transmit, via the communications interface, the aggregated response to the requestor system;
receive, via the communications interface, an authorized transaction from the requestor system before expiration of a second predetermined time period, the authorized transaction generated based on user input to a third interactive presentation displayed on the interactive GUI of the requestor system;
automatically initiate an execution process for the authorized transaction responsive to a third validation process, the execution process comprising sending one or more electronic messages to one or more external systems via the communications interface;
receive, via the communications interface, order execution details from an external system of the one or more external systems; and
transmit, via the communications interface, the order execution details to the requestor system and the one or more responder systems.

22. The non-transitory computer readable storage medium of claim 21, wherein an identity of the requestor system is anonymous in the request.

23. The non-transitory computer readable storage medium of claim 21, wherein an identity of a selected responder of the plurality of selected responders associated with the value of the one or more values for each component of the plurality of components is anonymous in one or more of the aggregated response and the order execution details.

24. The non-transitory computer readable storage medium of claim 21, wherein one or more of an identity of the requestor system and an identity of a selected responder of plurality of selected responders associated with the value of the one or more values for each component of the plurality of components is revealed in the order execution details.

25. The non-transitory computer readable storage medium of claim 21, wherein first validation process comprises:
determining one or more of a number of the plurality of components is above a minimum, a number of the one or more responder systems is above a minimum, at least one of the plurality of components are not repeated, the request includes a valid minimum threshold acceptance amount, and the request includes a selection of the first predetermined time period.

26. The non-transitory computer readable storage medium of claim 21, wherein the second validation process comprises:
determining a response of the one or more responses was received from a selected responder of the plurality of selected responders and a format of the one or more values is valid.

27. The non-transitory computer readable storage medium of claim 21, wherein the user input to the third interactive presentation comprises a selection of yes or no to the value of the one or more values for each component of the plurality of components.

28. The non-transitory computer readable storage medium of claim 27, wherein the third validation process comprises:
determining a number of the plurality of components having a yes selection for the value meets a minimum threshold.

29. The non-transitory computer readable storage medium of claim 21, wherein each component of the plurality of components is a bond order comprising one or more of an identification of a bond, a size, and a direction.

30. The non-transitory computer readable storage medium of claim 21, wherein the computer readable instructions, when executed by a processor, further cause the processor to:
determine a rating of one or more of the requestor system and each selected responder of the plurality of selected responders based on one or more metrics associated with previous transactions; and
update the rating of one or more of the requestor system and each selected responder of the plurality of selected responders based on the order execution details.
